(19) United States
(12) Patent Application Publication
(10) Pub. No.: US 2009/0259542 A1
(43) Pub. Date: Oct. 15, 2009

(54) System for Managing Incentive Programs via Mobile Networks

(76) Inventor: MILEN IOSSIFOV MISHKOVSKY, Coral Gables, FL (US)

Correspondence Address: ALEX STANCIOFF, 3801 HARLANO STREET, CORAL GABLES, FL, 33134, US

(21) Appl. No.: 12/418,465

(22) Filed: Apr. 3, 2009

Related U.S. Application Data
(60) Provisional application No. 61/044,562, filed on Apr. 14, 2008.

(51) Int. Cl. G06Q 30/00

(52) U.S. Cl. 705/14

(57) ABSTRACT

This invention relates to the description of a system for enabling the management of incentive-based transactions (like campaigns, promotions, requests for, and redemptions of incentives) on mobile networks, coupled with a network based service for sending, receiving and organizing such communications. The invention describes how a mobile device identifier (like a phone number) can be used to direct the flow of information pertaining to requests, responses, redemption and delivery of incentive-based services. The invention further describes how user behavior in incentive communications is measured, for individual and aggregate transactions in order to provide the consumer with relevance to better target future transactions. Finally the invention describes ways in which consumers are provided context-based guidance to better organize their search for incentives, and for redemption and delivery of incentive-based services.

### DESCRIPTION OF RELATED ART

The area of incentive-based communication is vast. For decades, people have worked with techniques for sending messages that elicit interest from various groups of people, with a promise of an incentive. In the field of advertising and marketing communications, such methods are common, and are employed on various visual and vocal media, and over various communication networks (including print, Web/Internet, Telephone and Mobile Networks).

Our invention specifically relates to use cases for incentives over mobile networks, although the principles described are network agnostic. In the area of mobile incentive communications, there is considerable prior art.

Prior art has described ways in which incentives (like coupons) are delivered to mobile phones, and that can later be redeemed by presenting them at a point-of-redemption.

Prior art as deployed in commonly available mobile phones allows users to browse to a website and avail of incentives from a web page.

Prior art also extensively describes how mobile surveys can be sent to users on mobile phones, and upon successful answers to surveys, users are presented incentives that can later be redeemed.

Prior art also describes numerous ways in which advertisements are delivered to mobile phones, via SMS, voice calls, web pages, etc. with various incentives.

In many of these descriptions of prior art, the creation of incentives is typically done on a computer application or via a web-based application, and subsequently the content describing the incentive is sent out to mobile phones. Customized web URL's, or SMS numbers are assigned to establish these communications, and recipients of such communications are asked to reply back to the originating sender's URL or SMS number or phone number, as the case may be. This approach is often tedious, in that the procurement of customized phone numbers or SMS numbers is difficult, expensive and hard to manage. Further, there is a burden on the users to remember various access codes, keywords etc. in order to request a particular incentive. Ultimately, as mobile devices are used to deliver and redeem a vast number of incentives, this approach is impractical for end users to manage.

Prior art that describes the use of coupons on mobile phones also suffer from limitations. Some offer ways in which coupons are stored on a mobile phone. These often are device specific, and do not work on all phones. Further, because the coupons are stored on the phone, if a device is shared or lost, so are the coupons, leading to complex workflows for the recovery of those coupons on new phones. Security and privacy are further considerations when coupons are stored on mobile phones.

Prior art also often describes ways in which advertisers send messages to mobile phones, often without the explicit permission or request by an end-user. This is often spam-like, unwanted, undesirable, and usually results in irate end-users, with unfortunate consequences for advertisers. Ultimately, a model that facilitates user-generated requests (directly generated by a user or derived from information about a user) is more sustainable. What is lacking then, is an intelligent way to learn about end-user behavior (individual and aggregate) and subsequently to empower the end-user to make intelligent decisions about searching for incentives, and for requesting and redeeming them.

The disadvantages with current approaches describe above form a basis for our invention. Our invention differs from prior art in the following respects:

a). We employ a mobile device's unique identifier and a user's unique identifier for the organization of a mobile campaign. The mobile device has a unique identifier that binds the user to the device, and this is used to manage the flow of information to/from the device/user.

b). The use of presence information to actively track the availability of a device/user, to track the behavior of the user in specific communications, to manage and organize information about user behavior, to aggregate information about other users in similar transactions, and to effectively target communications to/from the device and user.

c). The use of techniques to prompt users to search, request and redeem incentives based on relevancy is another key differentiator. Since a lot of information is collected about consumer behavior and about aggregate user behavior, the system of our invention can suggest and guide the consumer to search for incentives based on relevance to their needs (including attributes like presence, availability, location, time), instead of offering static incentives that are out of the consumer's current needs or context.

### BRIEF DESCRIPTION OF DRAWINGS

FIG. 100 illustrates an overview of the components of out invention.

FIG. 200 illustrates the high-level information flows between various elements of our invention.

### BACKGROUND

Please note that we will use the following terminology to describe the system of our invention:
An Entity is a general descriptor of any of the elements of the present invention.
An Incentive is an entity, indicative of a service, or goods, or an indication, identifier or access to services or goods.
A Provider is an entity, indicative of one who creates, manages and distributes incentives or incentive-based services.
A Consumer is an entity, indicative of one who requests or receives incentive communications, or incentives or incentive-based services.
An Information flow is an entity, indicative of any communication between any of the actors.
A Transaction is an entity, indicative of any exchange of entities between entities.

In the next section, we provide a detailed description of the system of our invention.

### DETAILED DESCRIPTION

For purposes of explanation, specific embodiments are set forth to provide a thorough understanding of the present invention. However, these embodiments merely illustrate the principles of the invention. It will thus be appreciated that those skilled in the art will be able to devise various arrangements, which, although not explicitly described or shown herein, embody the principles of the invention, and are included within its spirit and scope. Furthermore, all examples and conditional language that have been recited herein are principally intended expressly to be only for pedagogical purposes to aid the reader in understanding the principles of the invention and the concepts contributed by the inventors to furthering the art, and are to be construed as being without limitation to such specifically recited examples and conditions. Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the block diagrams herein represent conceptual views of illustrative circuitry embodying the principles of the invention. Similarly, it will be appreciated that any flow charts, flow diagrams, pseudocode and the like represent various processes which may be substantially represented in computer readable medium and so executed by a computer or processor, whether or not explicitly shown.

The functions of the various elements shown in the FIGS., including functional blocks labeled as “processors” or “servers” or “systems” may be provided through the use of dedicated hardware as well as hardware capable of executing software in association with appropriate software. When provided by a processor, server or computer, the functions may be provided by a single dedicated processor, by a single shared processor, or by a plurality of individual processors, some of which may be shared. Moreover, explicit use of the term “processor”, “server”, or “computer” should not be construed to refer exclusively to hardware capable of executing software, and may implicitly include, without limitation, digital signal processor (DSP) hardware, read-only memory (ROM) for storing software, random access memory (RAM), and non-volatile storage. Other hardware and/or software, conventional and/or custom, may also be included.

The system of the present invention is described through the figures.

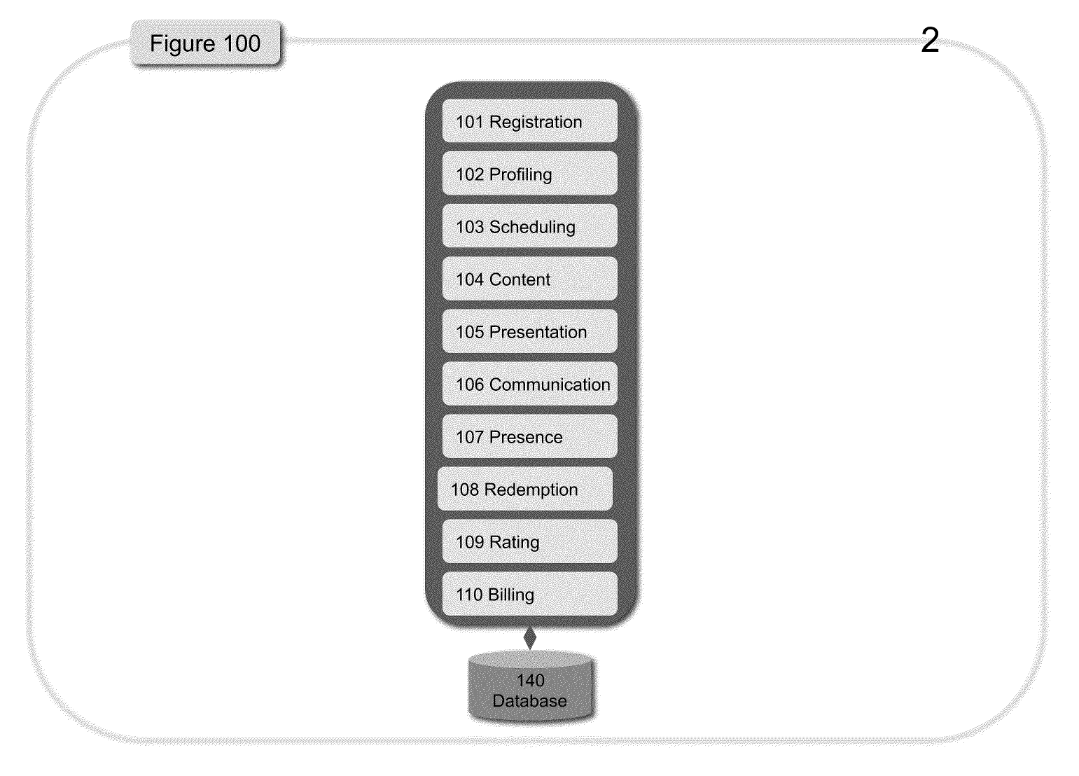

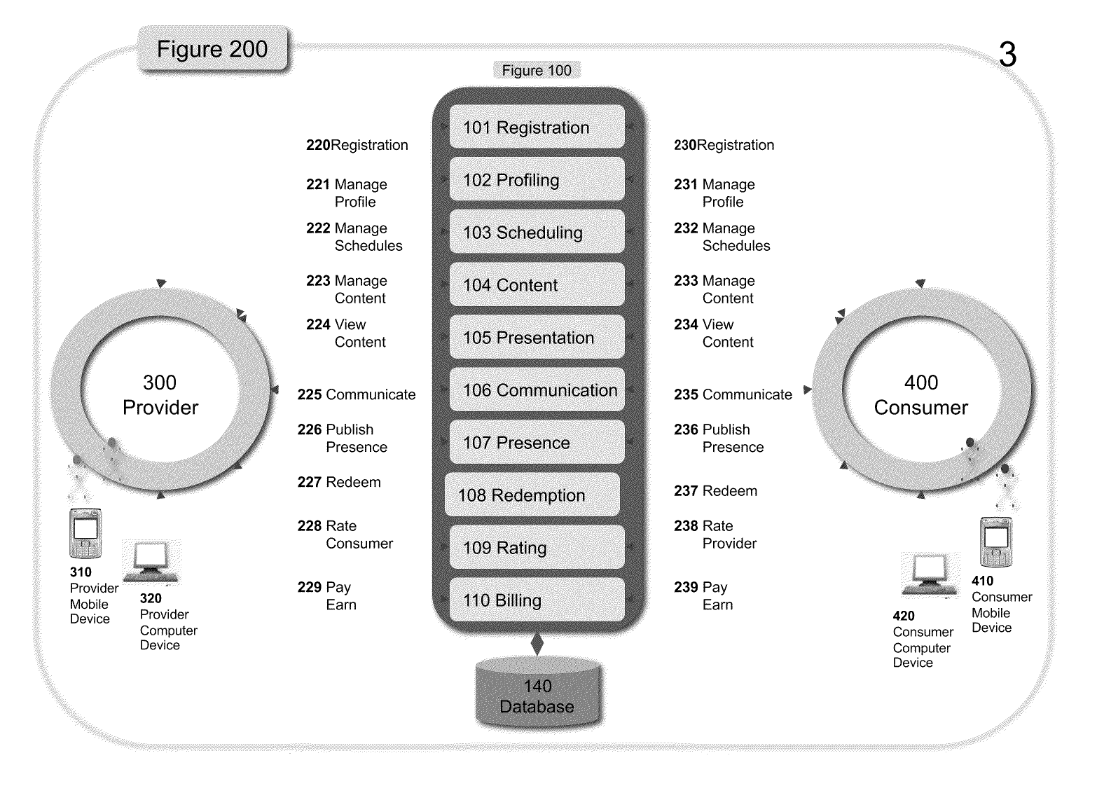

FIG. 100 illustrates a preferred embodiment of the structure of the present invention. The components of the invention include:
Unit 101—Registration Management: This unit is used to create attributes describing actors in the system, to establish unique identifiers for actors, and to establish their permissions to use the system. Registration can happen through direct access of this system by an actor who specifies attributes of other actors, or by the process of an actor requesting registration.
Unit 102—Profiling Management: This unit is used to process attributes of actors as defined in unit 101 and further establishing patterns that are indicative of potential needs, behavior or expected behavior of actors.
Unit 103—Scheduling Management: This unit is used to schedule the delivery or to indicate the availability of incentives or information flows between actors.
Unit 104—Content Management: This unit is used to create content descriptive of incentives in the system, or to create content to be communicated between actors.
Unit 105—Presentation Management: This unit is used to manipulate content created by unit 104 into a format best suited for delivery or viewing by various entities.
Unit 106—Communication Management: This unit is used to communicate content created by unit 104 among actors through any communication network or method.
Unit 107—Presence Management: This unit is used to determine the availability of actors to participate in an information flow, based on each actor's specified requirements, or by information derived through unit 101, 102 or 109.
Unit 108—Redemption Management: This unit is used to satisfy requests for redemption of incentives.
Unit 109—Rating Management: This unit is used to rate incentives, information flows or actors in comparison to established metrics.
Unit 110—Billing Management: This unit is used to handle transactions, typically financial transactions, required in the process of redeeming incentives.

Further, the components of FIG. 100 are coupled with a database unit 140 that holds information about the various actors, incentives, and information flows.

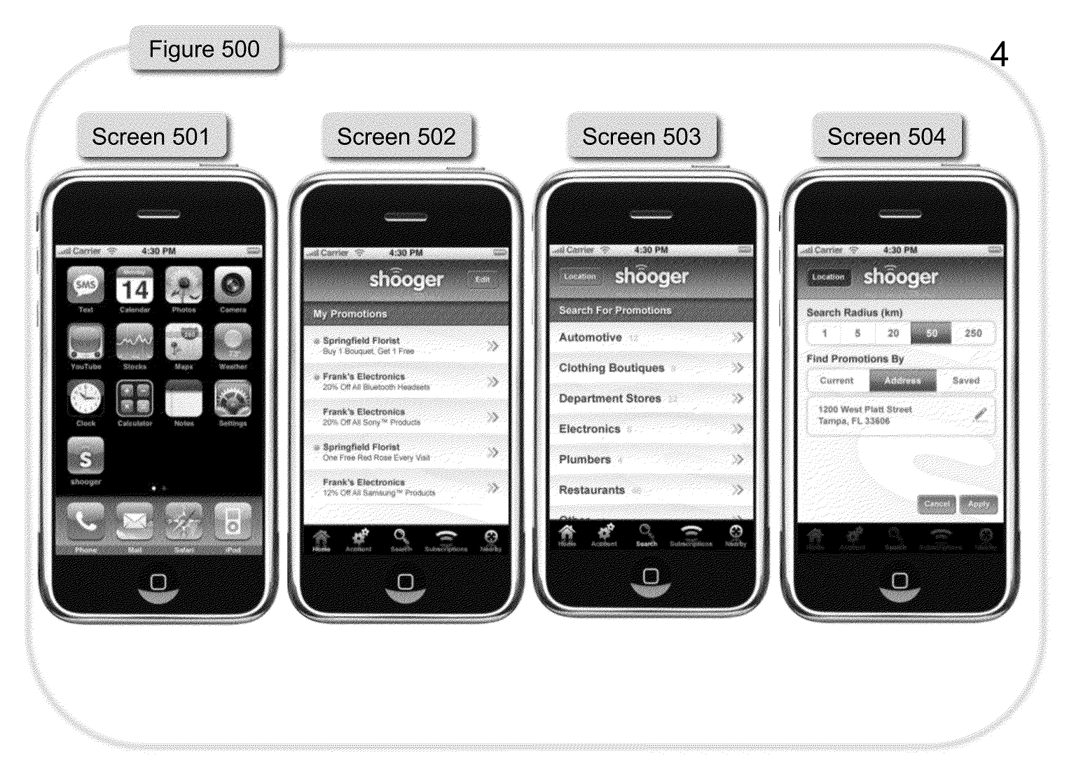

FIG. 200 illustrates the coupling of the components of FIG. 100 with other elements of the system:

Unit 300 is a specialized actor called a Provider, indicative of an actor who provides or manages incentives for distribution to other actors. Unit 400 is a specialized actor called a Consumer, indicative of an actor who requests, queries, searches or receives incentives. Units 300 and 400 are further coupled with one or more devices, such as phones, mobile phones, computers or other devices capable of communicating and handling information flows, coupled with any communication network, such as a telephone network, mobile network or the Internet.

Units 300 and 400 are marked with unique identifiers, in order to enable the proper receipt and transmission of information flows to and from themselves. These unique identifiers can be telephone numbers, uniform resource identifiers or other unique identifiers.

Let us now describe the invention through specific examples that illustrate its functionality.

In our example, a Provider Unit 300 wishes to offer an incentive to purchase services to a Consumer Unit 400. He reviews attributes of Consumer Unit 400 identified specifically, or in aggregate or via patterns that suggest attributes of Consumer Unit 400 through Unit 102, which maintains such information about Consumers. Provider Unit 300 uses this information to create a content describing attributes of said incentive, described by a set of attributes in Content Unit 104. Unit 300 then schedules this incentive through Scheduling Unit 103, to deliver the content to the Consumer 400 in one of several ways:
The content can be sent out to the Consumer 400 via unit 106 that couples with a communication network
Unit 400 can search for the content by querying Unit 104 based on various attributes that may identify the Content uniquely or through patterns that are indicative of the said Content
Unit 400 can subscribe to unit 104 to receive content satisfying specific criteria specified by attributes indicative of the said Content
Unit 400 can be sent communication by unit 106 indicating that said Content is available for retrieval by unit 400

Once said Content is scheduled, unit 107 is used to determine the availability of Consumer 140. Availability is determined by presence on the network, or by 140 indicating availability, or through a processing of attributes of unit 140, or reviewing historical attributes of 140, incentives it has received or information flows it has engaged in. Based on one of the models for delivering said Content, the Content is then delivered to unit 140.

Unit 140 can then review the said Content and determine if it wishes to redeem the incentive indicated by the said content. Redemption can include an expression to receive the incentive, or a transaction to purchase the incentive for instance through a cash payment. If desired, unit 140 then communicates through unit 106 and redemption is processed through unit 108. The redeemed incentive is sent to unit 400 through unit 106.

In the process of this information flow described above, Rating Unit 109 is used to rate various aspects of the information flow. This rating can include for instance the following methods:
Unit 400 can be queried by the rating unit 109 about attributes indicative of the quality of the incentive, or of unit 300, or other attributes that can be used to make a subjective or objective assessment of the information flow, incentive or Provider
Attributes of the information flow can be automatically processed by unit 109 and compared with other information flows to make an assessment about the present information flow
Unit 300 can be queried by unit 109 about attributes that can be used to make an assessment of the information flow, incentive or Consumer
Unit 300 could set up metrics when defining the said content that can be evaluated in the process of the information flow that can be processed by unit 109
Unit 400 could set up metrics in Profiling Unit 102 that can be processed by unit 109

The redemption of the incentive may involve a transaction that required a billing component, such as a financial transaction. For this purpose, unit 110 is used to process billing between actors, in this case, between the Provider and the Consumer.

Unit 500 shows an illustrative example of a functional mobile user interface that presents incentives to a user. Here, screen 501 shows an illustrative example of the appearance of an application that allows the user to access an interface to search, locate, view and redeem an incentive. Screen 502 shows an arrangement of incentives that a user has viewed and subsequently saved for future redemption. Screen 503 shows an illustrative method of organization of incentives, in this case through the use of visual categories that make sense as a logical grouping for an end user to easily organize and view incentives. Screen 504 shows a user interface used to specify location attributes that can be used to identify or present relevant incentives. In this example, proximity of an incentive to the user's preferred location is illustrated. So the use of a user defined address, or the use of an automated location finder such as a geographical positioning system, can assist in determining the proximity and availability of an incentive.

In the claims hereof any element expressed as a means for performing a specified function is intended to encompass any way of performing that function including, for example, a) a combination of circuit elements which performs that function or b) software in any form, including, therefore, firmware, microcode or the like, combined with appropriate circuitry for executing that software to perform the function. The invention as defined by such claims resides in the fact that the functionalities provided by the various recited means are combined and brought together in the manner which the claims call for. Applicant thus regards any means, which can provide these functionalities as being equivalent to those shown herein.

The embodiments of the invention in which an exclusive property or privilege is claimed are defined as follows:

1. A system comprising one or more entities, comprising
One or more Actors
One or more Incentives
One or more Information flows
One or more methods of communication

2. System of claim 1 wherein entities include human resources, systems or devices
System of claim 1 wherein incentives include services or goods, and indications of, or access to services or goods

3. System of claim 1 wherein information flows include establishment of qualification, trustworthiness or registration of actors for participation in the system, establishment of attributes for entities, processing of attributes to yield other attributes, distribution of entities, searching and requesting entities, ranking and rating of entities, and communications among entities.

4. System of claim 1 wherein methods of communication include the use of mobile networks, telephone networks, and packet or circuit based data networks

5. System of claim 1 wherein entities include devices such as telephones, mobile phones, smart phones, PDAs, televisions, computers, point-of-sale terminals, or any analog or digital hardware or software object capable of coupling with a method of communication

6. System of claim 3 wherein attributes for entities are coupled with unique identifiers

7. System of claim 6 wherein unique identifiers include telephone numbers, IMEI numbers, IP addresses and uniform resource identifiers

8. System of claim 1 wherein attributes of entities are monitored for availability of other entities to participate in information flows

9. System of claim 1 wherein attributes of entities are processed, said processing including comparison with attributes of other actors and processed

10. System of claim 9 wherein processing of attributes is used to determine ranking, relevance, management and control of information flows

11. System of claim 1 wherein entities are presented options to engage in information flows based on attributes of any entity

12. System of claim 11 wherein said options are further coupled with limits established by time to control their availability

13. System of claim 11 wherein said options are further coupled with limits on geographical location of entities, in order to control their availability

14. System of claim 11 wherein said options are further coupled with limits established by the presence or availability of other entities, in order to control their availability

15. System of claim 1 wherein an first entity uses a first communication method, coupled with a second entity using the same, different communication method, with said second actor coupled in an information flow with a third entity in order to redeem incentives

16. System of claim 15 wherein said redemption is by the first entity

17. System of claim 15 wherein said redemption is through said second entity on behalf of, and made available to said first entity

18. System of claim 15 wherein said redeemed incentive is transferred or delegated to any other entity
